(19) United States
(12) Patent Application Publication
(10) Pub. No.: US 2026/0122643 A1
(43) Pub. Date: Apr. 30, 2026

(54) SWITCHING PERIODS FOR MULTIPLE UPLINK FREQUENCIES

(71) Applicant: QUALCOMM Incorporated, San Diego, CA (US)

(72) Inventors: Yiqing CAO, Beijing (CN); Peter GAAL, San Diego, CA (US); Timo Ville VINTOLA, San Diego, CA (US)

(21) Appl. No.: 18/865,982

(22) PCT Filed: Jul. 27, 2022
(86) PCT No.: PCT/CN2022/108203

§ 371 Date: Nov. 14, 2024

(51) Int. Cl. H04W 72/21; H04B 7/0413; H04W 72/0453

(52) U.S. Cl. CPC H04W 72/21; H04B 7/0413; H04W 72/0453

(57) ABSTRACT

Aspects of the disclosure provide techniques for providing a UE capability indicating that the UE supports dynamic switching between a plurality of uplink frequencies within at least one frequency combination of at least three uplink frequencies. The UE capability may further indicate a respective switching period for each frequency pair within each of the one or more frequency combinations. The UE may further communicate with a network entity based on the UE capability.

### TECHNICAL FIELD

The technology discussed below relates generally to wireless communication systems, and more particularly, to configuring switching periods for frequency pairs within frequency combinations of three or more uplink frequencies.

### INTRODUCTION

In wireless communication systems, such as those specified under standards for 5G New Radio (NR), a user equipment (UE) may be capable of communicating with a network entity on a plurality of different frequencies. Each uplink frequency (e.g., uplink carrier frequency) may have an associated downlink frequency (e.g., downlink carrier frequency). For example, within FR1 (frequency range 1), there may be a number of different 5G NR bands, each including a respective downlink frequency band including at least one downlink frequency and a respective uplink frequency band including at least one respective uplink frequency. As an example, the n1 band includes the 1920 to 1980 MHz uplink frequency band and the 2110 to 2170 MHz downlink frequency band, for frequency division duplex (FDD) communication. Similarly, the n38 band includes the 2570 to 2620 MHz uplink frequency band and the 2570 to 2620 MHz downlink frequency band for time division duplex (TDD) communication.

There may also be one or more uplink frequency bands configured as supplementary uplink (SUL) carriers to extend uplink coverage. SUL carriers do not have an associated downlink carrier. Rather, the SUL carrier is added to the configured 5G NR band and shares the downlink carrier with the uplink carrier associated with the configured 5G NR band. In addition, a UE may support carrier aggregation of two or more uplink frequencies to increase bandwidth, thus providing higher data rates. In carrier aggregation, each uplink frequency may operate with a respective downlink frequency (e.g., within the same or different 5G NR bands) to support simultaneous scheduling of multiple uplink transmissions in parallel on the multiple uplink frequencies.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, user equipment (UE) is provided. The UE includes a transceiver configured to communicate with a network entity, a memory, and a processor coupled to the transceiver and the memory. The processor is configured to transmit a capability of the UE to switch between a plurality of uplink frequencies in at least one frequency combination to a network entity. Each of the at least one frequency combination including at least three uplink frequencies. The capability further indicating a respective switching period for each frequency pair within each of the at least one frequency combination. Each of the frequency pairs including two uplink frequencies of the at least three uplink frequencies. The processor is further configured to communicate with the network entity based on the capability.

Another example provides a method for wireless communication at a user equipment (UE). The method includes transmitting a capability of the UE to switch between a plurality of uplink frequencies in at least one frequency combination to a network entity. Each of the at least one frequency combination including at least three uplink frequencies. The capability further indicating a respective switching period for each frequency pair within each of the at least one frequency combination. Each of the frequency pairs including two uplink frequencies of the at least three uplink frequencies. The method further includes communicating with the network entity based on the capability.

Another example provides a network entity including a memory and a processor coupled to the memory. The processor is configured to receive a capability of a user equipment (UE) to switch between a plurality of uplink frequencies in at least one frequency combination. Each of the at least one frequency combination including at least three uplink frequencies. The capability further indicating a respective switching period for each frequency pair within each of the at least one frequency combination. Each of the frequency pairs including two uplink frequencies of the at least three uplink frequencies. The processor is further configured to communicate with the UE based on the capability.

Another example provides a method for wireless communication at a network entity. The method includes receiving a capability of a user equipment (UE) to switch between a plurality of uplink frequencies in at least one frequency combination. Each of the at least one frequency combination including at least three uplink frequencies. The capability further indicating a respective switching period for each frequency pair within each of the at least one frequency combination. Each of the frequency pairs including two uplink frequencies of the at least three uplink frequencies. The method further includes communicating with the UE based on the capability.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a wireless communication system according to some aspects.

FIG. 2 is a diagram illustrating an example of a radio access network (RAN) according to some aspects.

FIG. 3 is a schematic illustration of an organization of wireless resources in an air interface utilizing orthogonal frequency divisional multiplexing (OFDM) according to some aspects.

FIG. 4 is a diagram providing a high-level illustration of one example of a configuration of a disaggregated base station according to some aspects.

FIG. 5 illustrates an example of a wireless communication system supporting beamforming and/or multiple-input-multiple-output (MIMO) according to some aspects.

FIG. 6 is a diagram illustrating a multi-cell transmission environment according to some aspects.

FIGS. 7A and 7B are diagrams illustrating carrier aggregation and supplementary uplink according to some aspects.

FIG. 8 is a diagram illustrating an example of uplink frequency switching according to some aspects.

FIG. 9 is a signaling diagram illustrating exemplary signaling for uplink frequency switching according to some aspects.

FIG. 10 is a diagram illustrating an example of uplink communication using one or more frequency combinations according to some aspects.

FIGS. 11A and 11B are diagrams illustrating examples of respective capabilities of the UE to support dynamic switching between uplink frequencies of frequency combinations of three or more uplink frequencies according to some aspects.

FIG. 12 is a diagram illustrating another example of a capability of the UE to support dynamic switching between uplink frequencies of frequency combinations of three or more uplink frequencies according to some aspects.

FIG. 13 is a block diagram illustrating an example of a hardware implementation for a user equipment employing a processing system according to some aspects.

FIG. 14 is a flow chart of an exemplary process for communicating with a network entity based on an uplink frequency capability of a UE according to some aspects.

FIG. 15 is a block diagram illustrating an example of a hardware implementation for a network entity employing a processing system according to some aspects.

FIG. 16 is a flow chart of an exemplary process for communicating with a UE based on an uplink frequency switching capability of the UE according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

A UE may transmit a UE capability to a network entity (e.g., an aggregated or disaggregated base station) indicating that the UE supports dynamic switching between two uplink frequencies. The network entity may then communicate with the UE based on the UE capability. For example, the network entity may communicate with the UE on a first frequency of the two uplink frequencies and then configure the UE to dynamically switch to a second frequency of the two uplink frequencies. In some examples, the network entity may configure the UE to dynamically switch to the second uplink frequency to implement carrier aggregation, thereby increasing the bandwidth and/or improving uplink coverage, or to provide a higher data rate and/or improve uplink coverage with a supplementary uplink (SUL) carrier.

Switching between only two uplink frequencies may limit the ability of the UE to achieve a target bandwidth or data rate. Therefore, in some aspects, a UE may be capable of dynamically switching between more than two uplink frequencies. To support switching between frequency combinations of three or more uplink frequencies, a new UE capability may be defined to indicate the capability of the UE to support dynamic switching between frequency combinations.

Various aspects of the disclosure provide a UE capability indicating that the UE supports dynamic switching between a plurality of uplink frequencies within at least one frequency combination of at least three uplink frequencies. Each of the at least three uplink frequencies may include a different carrier from the same or different uplink frequency bands. The UE capability may further indicate a respective switching period for each frequency pair within each of the one or more frequency combinations. The switching period specifies a duration of time within which the UE is able to switch one or more antennas from one of the uplink frequencies to the other uplink frequency.

In some examples, the switching period of a frequency pair is different between different frequency combinations. In some examples, the switching period of one frequency pair in a frequency combination may be different than the switching period of another frequency pair in a frequency combination. In some examples, the UE may not support direct switching between one of the frequency pairs in a frequency combination. In some examples, the UE capability may exclude a switching period of the unsupported frequency pair. In other examples, an uplink frequency common to other supported frequency pairs including uplink frequencies of the unsupported frequency pair may serve as an anchor uplink frequency providing a bridge between the uplink frequencies of the unsupported frequency pair. In some examples, the UE capability may further indicate the number of supported antennas or layers (e.g., multiple-input-multiple-output (MIMO) layers) for each uplink frequency in the frequency combination. In addition, the UE capability may indicate the number of antennas or layers for each uplink frequency that are enabled to switch to a different uplink frequency in the frequency combination.

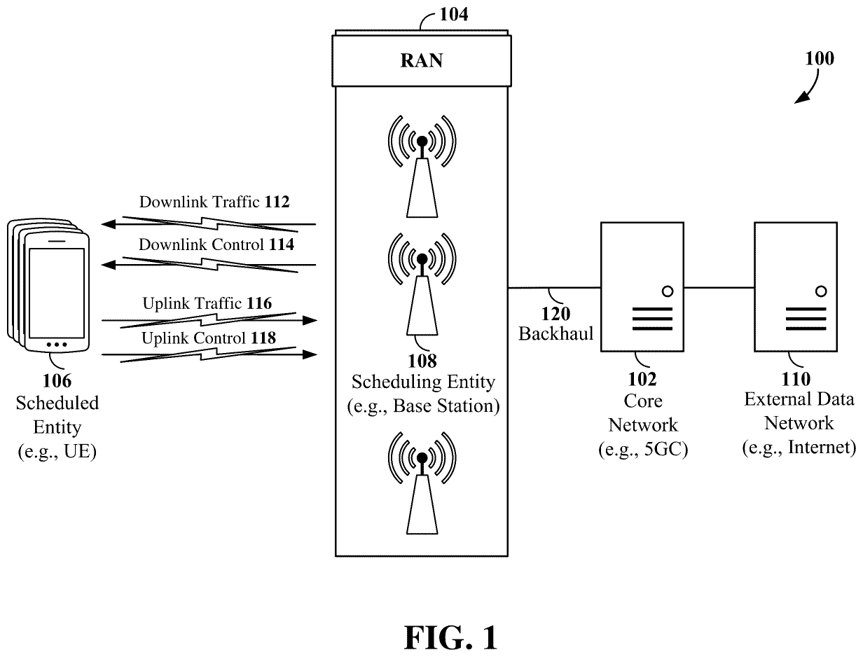

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station. In addition, one or more of the base stations may have a disaggregated configuration.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmissions. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic 112 and/or 116 information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

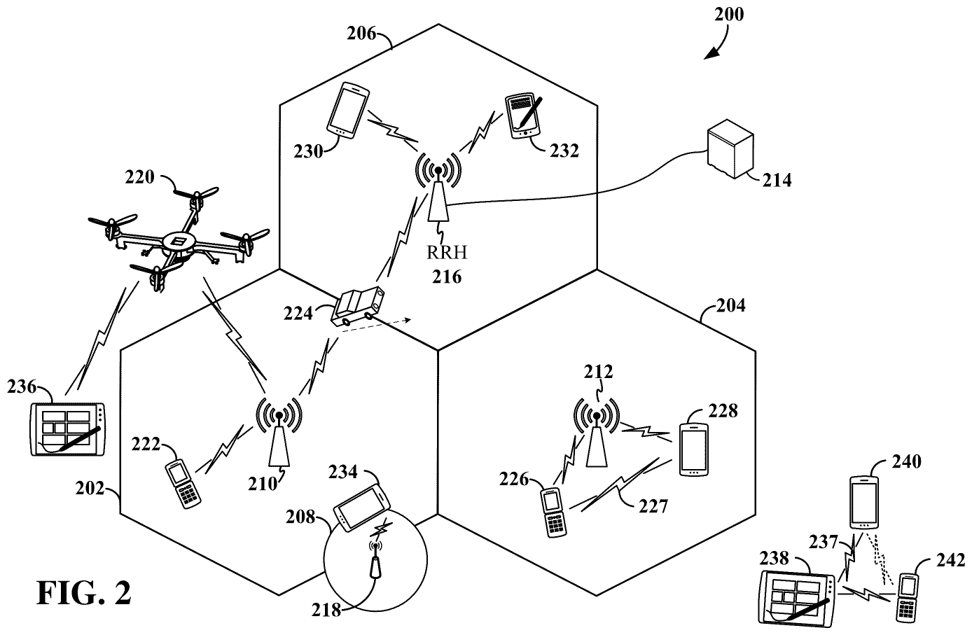

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

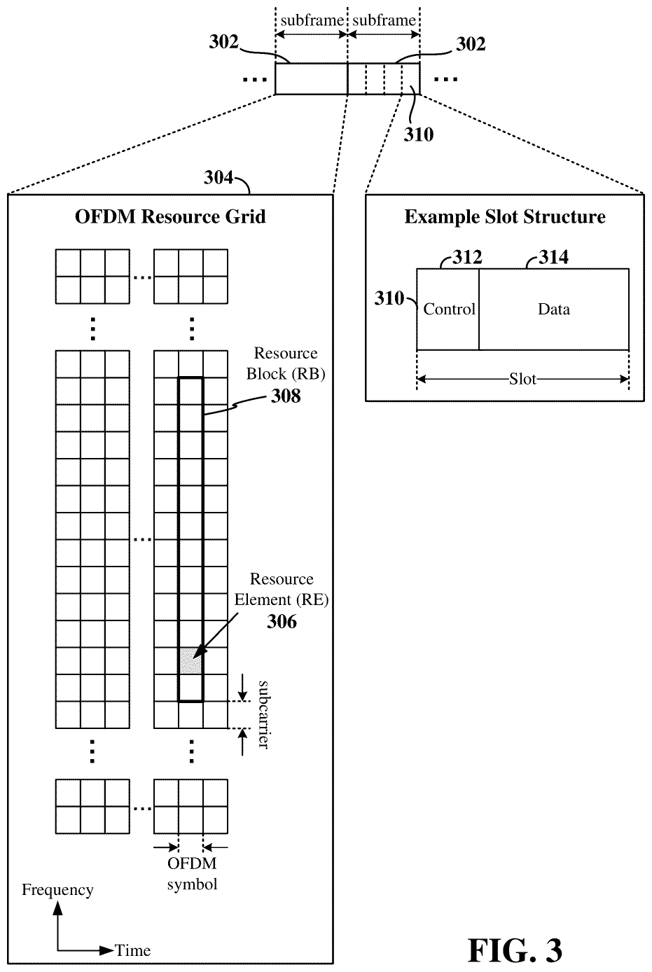

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgement (ACK) or negative acknowledgement (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

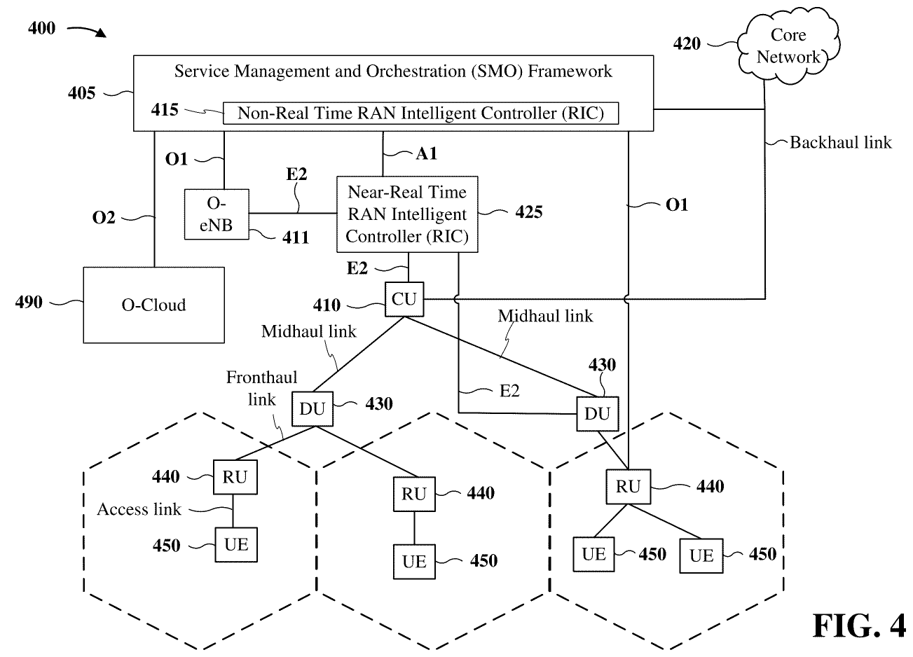

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 450 via one or more radio frequency (RF) access links. In some implementations, the UE 450 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 450. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

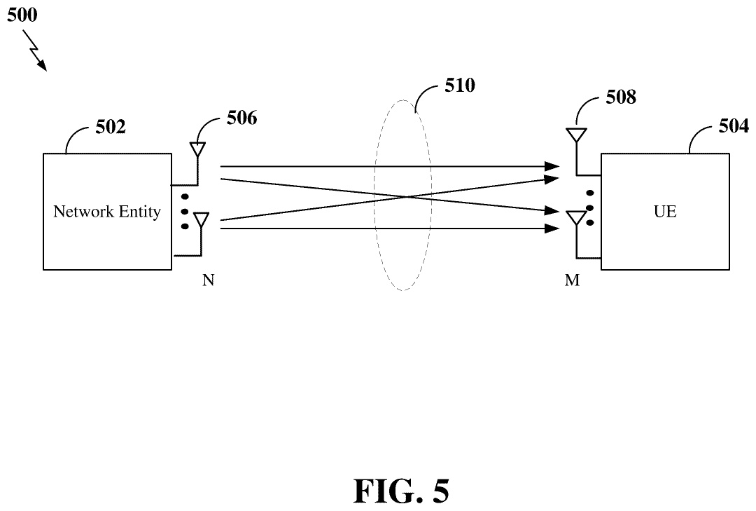

In some aspects of the disclosure, network entities and/or UEs may be configured for beamforming and/or multiple-input-multiple-output (MIMO) technology. FIG. 5 illustrates an example of a wireless communication system supporting beamforming between a network entity 502 and a UE 504 and/or MIMO. In a MIMO system, the network entity 502 includes multiple network entity antennas 506 (e.g., N antennas) and a UE 504 includes multiple UE antennas 508 (e.g., M antennas). Thus, there are N×M signal paths 510 from the network entity antennas 506 to the UE antennas 508. Each antenna 506 and 508 corresponds, for example, to an antenna port of an antenna array or antenna panel. Here, the term antenna port refers to a logical port (e.g., a beam) over which a signal (e.g., a data stream or layer) may be transmitted. In an example, each of the network entity 502 and UE 504 may include one or more antenna arrays (or antenna panels), each including a plurality of antenna elements. The antenna elements of an antenna panel may be mapped to antenna ports on the antenna panel by antenna element combiners.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple network entity antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the network entity to identify the source of each spatially precoded data stream.

The number of data streams or layers corresponds to the rank of the transmission. In general, the rank of the MIMO system 500 is limited by the number of network entity antennas 506 or UE antennas 508, whichever is lower. In addition, the channel conditions at the UE, as well as other considerations, such as the available resources at the network entity, may also affect the transmission rank. For example, the rank (and therefore, the number of data streams) assigned to a particular UE on the downlink may be determined based on the rank indicator (RI) transmitted from the UE to the network entity. The RI may be determined based on the antenna configuration (e.g., the number of network entity antennas and UE antennas) and a measured signal-to-interference-and-noise ratio (SINR) on each of the UE antennas. The RI may indicate, for example, the number of layers that may be supported under the current channel conditions. The network entity may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the network entity may assign the rank for DL MIMO transmissions based on UL SINR measurements (e.g., based on a Sounding Reference Signal (SRS) transmitted from the UE or other pilot signal). Based on the assigned rank, the network entity may then transmit CSI-RSs with separate C-RS sequences for each layer to provide for multi-layer channel estimation. From the CSI-RS, the UE may measure the channel quality across layers and resource blocks and feed back the RI and a channel quality indicator (CQI) that indicates to the network entity a modulation and coding scheme (MCS) to use for transmissions to the UE for use in updating the rank and assigning REs for future downlink transmissions.

In one example, as shown in FIG. 5, a rank-2 spatial multiplexing downlink transmission on a 2×2 MIMO antenna configuration will transmit one data stream from each network entity antenna 506. Each data stream reaches each UE antenna 508 along a different signal path 510. The UE 504 may then reconstruct the data streams using the received signals from each UE antenna 508.

Beamforming is a signal processing technique that may be used at the network entity 502 and UE 504 to shape or steer an antenna beam (e.g., a transmit beam or receive beam) along a spatial path between the network entity 502 and the UE 504. Beamforming may be achieved by combining the signals communicated via antennas 506 and 508 such that some of the signals experience constructive interference while others experience destructive interference. To create the desired constructive/destructive interference, the network entity 502 may apply amplitude and/or phase offsets to signals transmitted or received from each of the antennas 506. The UE 504 may further be configured with one or more beamforming antennas 508 (e.g., antenna panels) to transmit and/or receive beamformed signals to and/or from the network entity 502.

Wireless communication networks, such as 4G LTE and/or 5G NR networks, may further support carrier aggregation in a multi-cell transmission environment where, for example, different network entities and/or different transmission and reception points (TRPs) may communicate on different component carriers within overlapping cells. In some aspects, the term component carrier may refer to a carrier frequency utilized for communication within a cell.

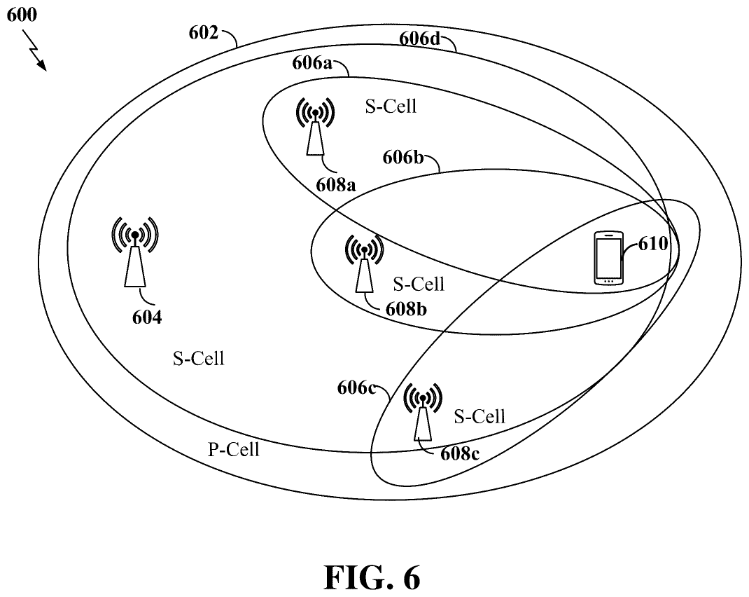

FIG. 6 is a diagram illustrating a multi-cell transmission environment 600 according to some aspects. The multi-cell transmission environment 600 includes a primary serving cell (PCell) 602 and one or more secondary serving cells (SCells) 606a, 606b, 606c, and 606d. The PCell 602 may be referred to as the anchor cell that provides a radio resource control (RRC) connection to a UE (e.g., UE 610).

When carrier aggregation is configured in the multi-cell transmission environment 600, one or more of the SCells 606a-606d may be activated or added to the PCell 602 to form the serving cells serving the UE 610. In this case, each of the serving cells corresponds to a component carrier (CC). The CC of the PCell 602 may be referred to as a primary CC, and the CC of a SCell 606a-606d may be referred to as a secondary CC.

Each of the PCell 602 and the SCells 606a-606d may be served by a transmission and reception point (TRP). For example, the PCell 602 may be served by TRP 604 and each of the SCells 606a-606c may be served by a respective TRP 608a-608c. Each TRP 604 and 608a-608c may be a base station (e.g., aggregated base station), remote radio head of a gNB, a radio unit (RU) of disaggregated RAN architecture, or other scheduling entity similar to those illustrated in any of FIGS. 1, 2, and/or 4. In some examples, the PCell 602 and one or more of the SCells (e.g., SCell 606d) may be co-located. For example, a TRP for the PCell 602 and a TRP for the SCell 606d may be installed at the same geographic location. Thus, in some examples, a TRP (e.g., TRP 604) may include multiple TRPs, each corresponding to one of a plurality of co-located antenna arrays, and each supporting a different carrier (different CC). However, the coverage of the PCell 602 and SCell 606d may differ since different component carriers may experience different path loss, and thus provide different coverage.

The PCell 602 is responsible not only for connection setup, but also for radio resource management (RRM) and radio link monitoring (RLM) of the connection with the UE 610. For example, the PCell 602 may activate one or more of the SCells (e.g., SCell 606a) for multi-cell communication with the UE 610 to improve the reliability of the connection to the UE 610 and/or to increase the data rate. In some examples, the PCell may activate the SCell 606a on an as-needed basis instead of maintaining the SCell activation when the SCell 606a is not utilized for data transmission/reception in order to reduce power consumption by the UE 610.

In some examples, the PCell 602 may be a low band cell, and the SCells 606 may be high band cells. A low band (LB) cell uses a CC in a frequency band lower than that of the high band cells. For example, the high band cells may each use a respective mmWave CC (e.g., FR2 or higher), and the low band cell may use a CC in a lower frequency band (e.g., sub-6GHz band or FR1). In general, a cell using an FR2 or higher CC can provide greater bandwidth than a cell using an FR1 CC. In addition, when using above −6 GHz frequency (e.g., mmWave) carriers, beamforming may be used to transmit and receive signals.

In some examples, the PCell 602 may utilize a first radio access technology (RAT), such as LTE, while one or more of the SCells 606 may utilize a second RAT, such as 5G-NR. In this example, the multi-cell transmission environment may be referred to as a multi-RAT-dual connectivity (MR-DC) environment. One example of MR-DC is an Evolved-Universal Terrestrial Radio Access Network-New Radio dual connectivity (EN-DC) mode that enables a UE to simultaneously connect to an LTE base station and a NR base station to receive data packets from and send data packets to both the LTE base station and the NR base station.

In some examples, instead of aggregating multiple carriers, a UE may be configured with both an uplink carrier and a supplementary uplink (SUL) carrier. The SUL carrier may be, for example, at a lower frequency to provide higher data rates with lower path loss.

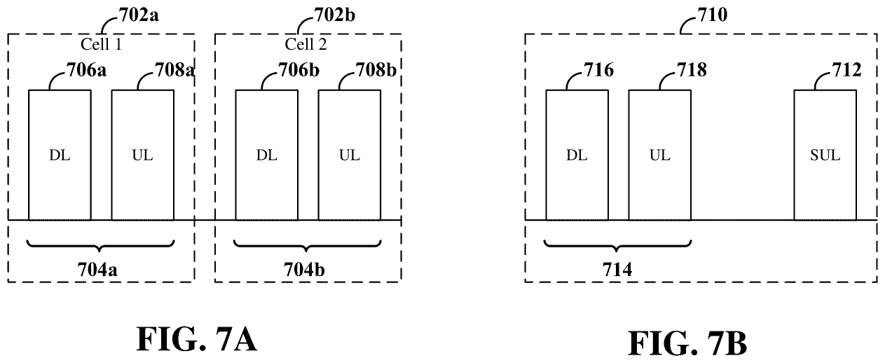

FIGS. 7A and 7B are diagrams illustrating carrier aggregation and supplementary uplink according to some aspects. As shown in FIG. 7A, in carrier aggregation (CA), a UE is simultaneously connected to multiple cells 702a and 702b in a multi-cell environment. Each cell communicates with the UE using a respective downlink frequency and a respective uplink frequency. For example, a cell may communicate with a UE using respective downlink/uplink frequencies (e.g., carriers) within a 5G NR band 704a and 704b, which includes a respective downlink frequency band 706a/706b and a respective uplink frequency band 708a/708b. In SUL scenarios, as shown in FIG. 7B, a SUL carrier 712 is added in the same cell 710. The SUL carrier 712 does not have a separate downlink carrier associated with it. Instead, the SUL carrier 712 shares a downlink carrier 716 with an uplink carrier 718 associated with a 5G NR band 714 including the uplink carrier 718 and the respective downlink carrier 716.

In carrier aggregation (CA), EN-DC, SUL, and other scenarios, the UE may support dynamic switching between uplink frequencies in the same or different bands. For example, a UE may support switching between two uplink frequencies. In this example, the UE may report a capability of the UE to perform switching between the two uplink frequencies and may further report a switching period for switching between the two uplink frequencies to the network entity. The switching period specifies a duration of time within which the UE is able to switch one or more antennas from one of the uplink frequencies to the other uplink frequency.

In various aspects, a UE may be capable of switching among more than two uplink frequencies. However, the switching period may vary between each frequency pair of two uplink frequencies within a frequency combination of at least three uplink frequencies. For example, in a frequency combination of three uplink frequencies (UL1,UL2, and UL3), the switching period of a first frequency pair containing UL1 and UL2may be different than the switching period of a second frequency pair containing UL2 and UL3, and the switching periods of both the first and second frequency pairs may be different than the switching period of a third frequency pair containing UL1 and UL3.Moreover, the switching period of the same frequency pair may vary between frequency combinations. For example, the switching period of the first frequency pair containing UL1 and UL2 within a frequency combination of UL1, UL2, and UL3 may be different than the switching period of the first frequency pair within a frequency combination of UL1, UL2, and UL4. In addition, the number of antennas or MIMO layers supported on an uplink frequency may be different than the number of antennas or MIMO layers that can be switched on that uplink frequency for a frequency combination. For example, the UE may support two antennas on UL1, but only one of the two antennas may be able to be switched.

Therefore, various aspects are related to a UE capability provided from the UE to a network entity that indicates the UE is capable of switching between a plurality of uplink frequencies in at least one frequency combination of at least three uplink frequencies. The UE capability may further indicate a respective switching period between each frequency pair within each of the frequency combinations. In addition, the UE capability may further indicate a respective number of antennas or MIMO layers for an uplink frequency within a frequency combination that may be switched.

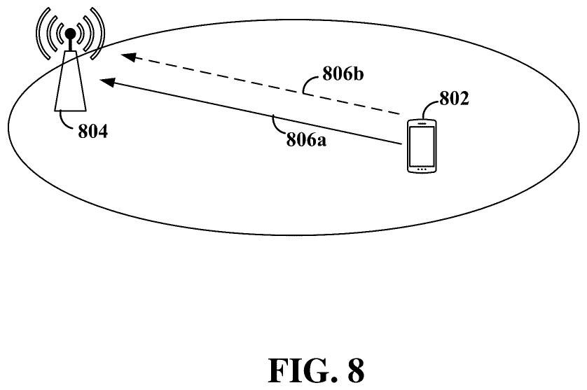

FIG. 8 is a diagram illustrating an example of uplink frequency switching between a UE 802 and a network entity 804 according to some aspects. The UE 802 may correspond, for example, to any of the UEs or other scheduled entities shown in FIGS. 1, 2, 5, and/or 6. The network entity 804 may correspond, for example, to any of the network entities (e.g., a base station or gNB in an aggregated base station architecture, or a central unit (CU), a distributed unit (DU), a radio unit (RU), a Near-Real Time (Near-RT) RAN Intelligent Controller (RIC), or a Non-Real Time (Non-RT) RIC in a disaggregated base station architecture) shown in FIGS. 1, 2, and/or 4-6.

In the example shown in FIG. 8, a UE 802 may communicate with a network entity 804 on a first uplink frequency 806a. The UE 802 may communicate on the first uplink frequency 806a using one or more antennas of the UE 802. In some examples, to facilitate carrier aggregation, EN-DC, or SUL, the network entity 804 may configure the UE 802 (e.g., transmit a message via medium access control (MAC) control element (MAC-CE) or DCI to the UE 802) to dynamically switch from the first uplink frequency 806a to a second uplink frequency 806b. In some examples, the second uplink frequency 806b corresponds to a SUL carrier. In other examples, the second uplink frequency 806b is within a configured 5G NR band. For example, within FR1, there may be a number of different 5G NR bands, each including at least one respective downlink frequency and at least one respective uplink frequency for FDD or TDD communication. The UE 802 may switch from the first uplink frequency 806a of one of the 5G NR bands to the second uplink frequency 806b of the same or another 5G NR band.

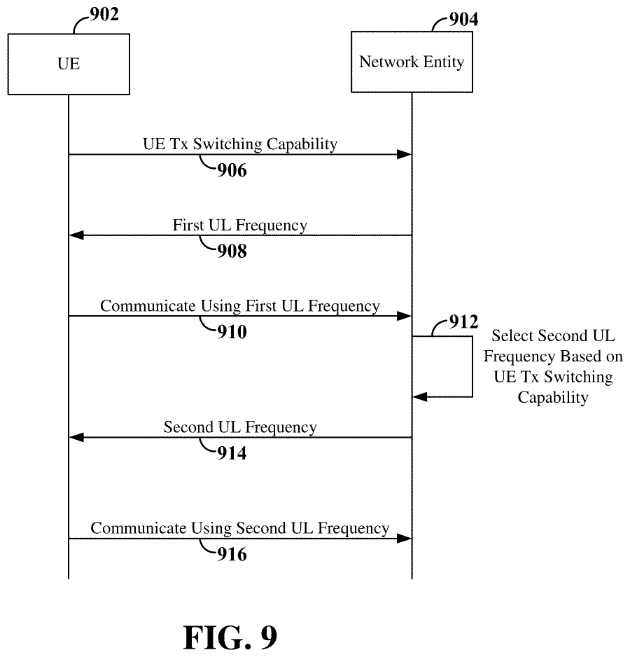

FIG. 9 is a signaling diagram illustrating exemplary signaling between a UE 902 and a network entity 904 for uplink frequency switching according to some aspects. The UE 902 may correspond, for example, to any of the UEs or other scheduled entities shown in FIGS. 1, 2, 5, 6, and/or 8. The network entity 904 may correspond, for example, to any of the network entities (e.g., a base station or gNB in an aggregated base station architecture, or a central unit (CU), a distributed unit (DU), a radio unit (RU), a Near-Real Time (Near-RT) RAN Intelligent Controller (RIC), or a Non-Real Time (Non-RT) RIC in a disaggregated base station architecture) shown in FIGS. 1, 2, 4-6, and/or 8.

At 906, the UE 902 may transmit a capability of the UE 902 to the network entity 904. The capability may include a UE Tx Switching Capability indicating that the UE supports dynamic switching between a plurality of uplink frequencies in at least one frequency combination of at least three uplink frequencies (e.g., three or more uplink frequencies). The capability may further indicate a respective switching period for each frequency pair (e.g., including two uplink frequencies) within each of the frequency combination(s). In some examples, the switching period may vary between respective frequency pairs within a frequency combination. For example, within a frequency combination including three uplink frequencies, the switching period of a first frequency pair including a first uplink frequency and a second uplink frequency may be different than the respective switching periods of a second frequency pair including the first uplink frequency and a third uplink frequency and a third frequency pair including the second uplink frequency and the third uplink frequency. In some examples, the switching period of a first frequency pair may vary between different frequency combinations. For example, the switching period of the first frequency pair may be a first value in a first frequency combination and a second value different than the first value in a second frequency combination. In some examples, the switching period of each frequency pair may be reported as a value of a predetermined value set. For example, the value set may include 35 μs, 140 μs, and 210 μs. Thus, each switching period may have a value equal to one of 35 μs, 140 μs, or 210 μs.

In some examples, direct switching between two uplink frequencies of a frequency pair within a frequency combination may not be supported. In this example, the capability may exclude a switching period of a frequency pair within a frequency combination to indicate that switching between the two uplink frequencies of that frequency pair (e.g., a first frequency pair) is unsupported. In some examples, the UE may support switching between the two uplink frequencies of that frequency pair (e.g., the first frequency pair) in another frequency combination, and therefore, may include a switching period for the first frequency pair in the other frequency combination.

In some examples, at least one uplink frequency may serve as an anchor uplink frequency to enable switching to/from other uplink frequencies when direct switching between all frequency pairs in a frequency combination is not supported. For example, two frequency pairs within a frequency combination may include the same anchor uplink frequency that enables switching between the uplink frequencies of another frequency pair in the frequency combination. As an example, direct switching between a first frequency pair (e.g., UL1 and UL2) in the frequency combination may not be supported. In this example, the first switching period of the first frequency pair (e.g., UL1 and UL2) can correspond to a combination of a second switching period of a second frequency pair (e.g., UL1 and UL3) within the frequency combination and a third switching period of a third frequency pair (e.g., UL2 and UL3) within the frequency combination. Here, the first switching period may be equal to the sum of the second switching period and the third switching period. Thus, the second frequency pair and the third frequency pair may each include an anchor uplink frequency (e.g., UL3) that provides a bridge between a first uplink frequency (e.g., UL1) of the first frequency pair and a second uplink frequency (e.g., UL2) of the second frequency pair. In some examples, the capability excludes the first switching period of the first frequency pair within the first frequency combination. For example, the switching period of the first frequency pair may not be one of the predetermined switching period values (e.g., the switching period is a combination of predetermined switching period values). In this example, the network entity 904 can deduce or determine the first switching period based on the second switching period and the third switching period included in the capability.

In some examples, the capability may further indicate a number of antennas or MIMO layers supported by each of the plurality of uplink frequencies within a frequency combination. In addition, the capability may further indicate a number of antennas or MIMO layers for each of the uplink frequencies within the frequency combination that are allowed or enabled to switch to a different uplink frequency within the frequency combination. For example, an uplink frequency (e.g., UL1) may support two antennas or MIMO layers, but only one of the antennas or MIMO layers may be able to be switched from UL1 to one of the other uplink frequencies (e.g., UL2 or UL3) within the frequency combination.

At 908 and 910, the network entity 904 can indicate a first uplink frequency for the UE 902 to use for communication with the network entity 904 on the uplink. For example, the first uplink frequency may be part of a 5G NR band including the first uplink frequency and a downlink frequency. In some examples, the first uplink frequency may be determined based on a frequency reuse pattern of the network and the 5G NR band assigned to a serving cell of the UE 902. To implement carrier aggregation (CA) or EN-DC or to extend uplink coverage, at 912 and 914, the network entity 904 may select a second uplink frequency based on the UE Tx Switching Capability. For example, the network entity 904 may select an SCell or may select a SUL carrier in the PCell or an SCell for the UE 902 based on the UE Tx Switching Capability. At 916, the UE 902 may then switch one or more antennas (or MIMO layers) to the second uplink frequency (e.g., for CA, EN-DC, or SUL) for communication with the network entity 904 on the second uplink frequency.

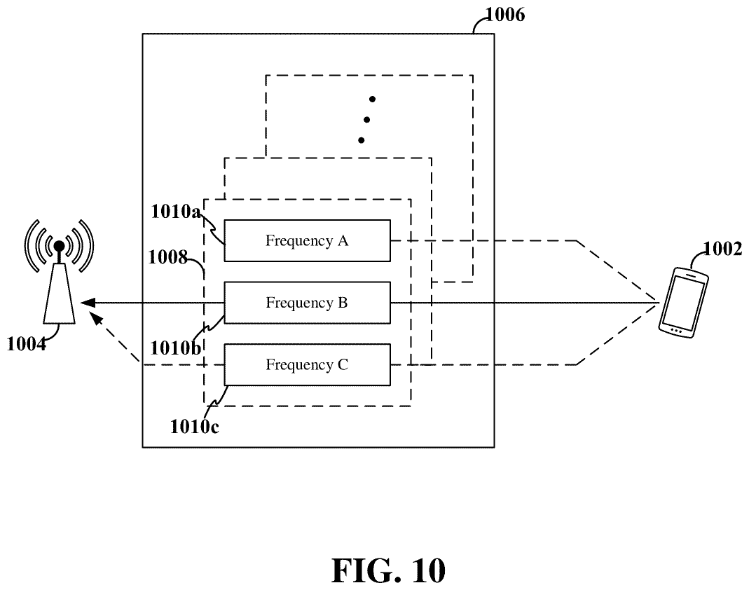

FIG. 10 is a diagram illustrating an example of uplink communication between a UE 1002 and a network entity 1004 using one or more frequency combinations according to some aspects. The UE 1002 may correspond, for example, to any of the UEs or other scheduled entities shown in FIGS. 1, 2, 5, 6, 8, and/or 9. The network entity 1004 may correspond, for example, to any of the network entities (e.g., a base station or gNB in an aggregated base station architecture, or a central unit (CU), a distributed unit (DU), a radio unit (RU), a Near-Real Time (Near-RT) RAN Intelligent Controller (RIC), or a Non-Real Time (Non-RT) RIC in a disaggregated base station architecture) shown in FIGS. 1, 2, 4-6, 8, and/or 9.

In the example shown in FIG. 10, the UE 1002 may provide a capability 1006 of the UE to the network entity 1004. The capability 1006 indicates that the UE 1002 supports one or more frequency combinations 1008, each including three or more uplink frequencies (e.g., uplink frequencies 1010a, 1010b, and 1010c). The UE 1002 may communicate with the network entity 1004 using an uplink frequency (e.g., uplink frequency 1010b) of a frequency combination 1008. Based on the capability 1006, the network entity 1004 may configure the UE 1002 (e.g., transmit a message to the UE 1002) to switch one or more antennas (or MIMO layers) of the UE 1002 to a different uplink frequency (e.g., uplink frequency 1010c). For example, the network entity 1004 may request the UE 1002 to switch one or more UE Tx antennas (or MIMO layers) to uplink frequency 1010c to implement CA or EN-DC or to extend uplink coverage with a SUL carrier.

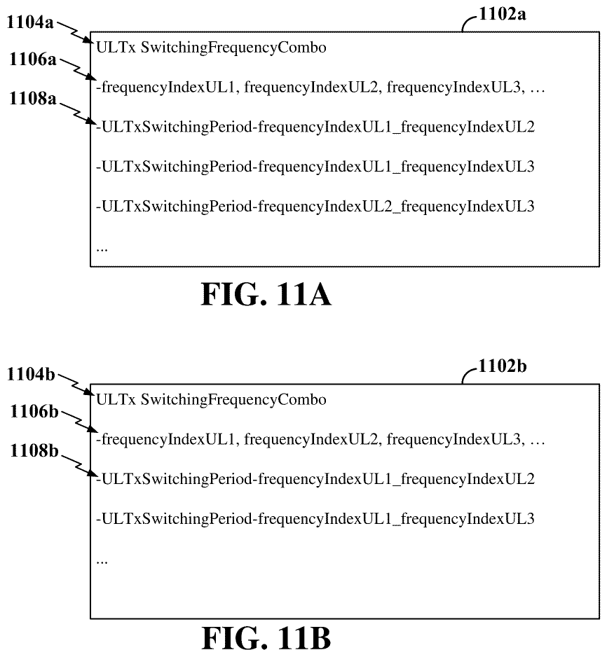

FIGS. 11A and 11B are diagrams illustrating examples of respective capabilities 1102a and 1102b of the UE to support dynamic switching between uplink frequencies in frequency combinations of three or more uplink frequencies. In the example shown in FIG. 11A, the capability 1102a includes an uplink frequency switching capability of a frequency combination 1104a (e.g., ULTx SwitchingFrequencyComb). The capability 1102a further includes a respective identifier 1106a of each of a plurality of uplink frequencies (e.g., frequencyIndexUL1, frequencyIndexUL2, frequencyIndexUL3, . . . ) in the frequency combination 1104a. In addition, the capability 1102a includes a respective switching period 1108a for each frequency pair within the frequency combination 1104a. For example, the capability 1102a can include at least a first switching period for switching between a first frequency pair (e.g., ULTxSwitchingPeriod-frequencyIndexUL1_frequencyIndexUL2), a second switching period for switching between a second frequency pair (e.g., ULTxSwitchingPeriod-frequencyIndexUL1_frequencyIndexUL3), and a third switching period for switching between a third frequency pair (e.g., ULTxSwitchingPeriod-frequencyIndexUL2_frequencyIndexUL3).

In the example shown in FIG. 11B, the capability 1102b includes an uplink frequency switching capability of a frequency combination 1104b (e.g., ULTx SwitchingFrequencyComb). The capability 1102b further includes a respective identifier 1106b of each of a plurality of uplink frequencies (e.g., frequencyIndexUL1, frequencyIndexUL2, frequencyIndexUL3, . . . ) in the frequency combination 1104b. In addition, the capability 1102b includes a respective switching period 1108a for at least some of the frequency pairs within the frequency combination 1104b. In this example, direct switching between the uplink frequencies of at least one frequency pair may not be supported. For example, the capability 1102b can include a first switching period for switching between a first frequency pair (e.g., ULTxSwitchingPeriod-frequencyIndexUL1_frequencyIndexUL2) and a second switching period for switching between a second frequency pair (e.g., ULTxSwitchingPeriod-frequencyIndexUL1_frequencyIndexUL3). However, the capability 1102b may exclude a third switching period for switching between a third frequency pair (e.g., the frequency pair formed by frequencyIndexUL2 and frequencyIndexUL3) to indicate that direct switching between the third frequency pair is unsupported. In some examples, the network entity may infer the switching period of the third frequency pair based on the switching periods of the first frequency pair and the second frequency pair. For example, each of the first and second frequency pairs includes frequencyIndexUL1, which can serve as an anchor frequency to provide a bridge between frequencyIndexUL2 and frequencyIndexUL3. It should be understood that the capabilities 1102a and 1102b may each include additional frequency combinations (not shown) with different combinations of three or more uplink frequencies.

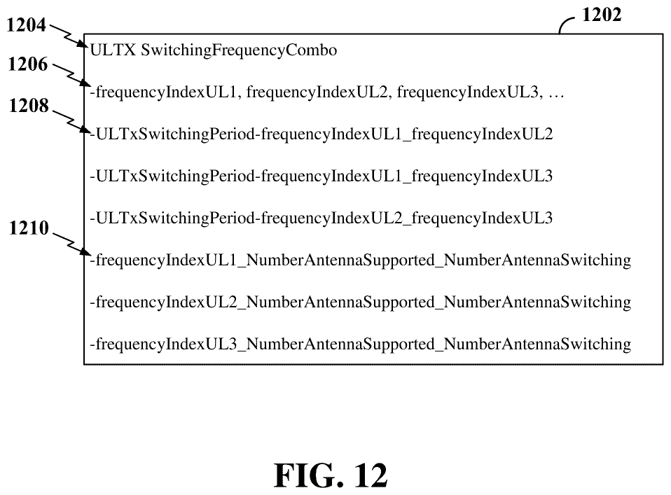

FIG. 12 is a diagram illustrating another example of a capability 1202 of the UE to support dynamic switching between frequency combinations of three or more uplink frequencies according to some aspects. In the example shown in FIG. 12, the capability 1202 includes an uplink frequency switching capability of a frequency combination 1204 (e.g., ULTx SwitchingFrequencyComb). The capability 1202 further includes a respective identifier 1206 of each of a plurality of uplink frequencies (e.g., frequencyIndexUL1, frequencyIndexUL2, frequencyIndexUL3, . . . ) in the frequency combination 1204. In addition, the capability 1202 includes a respective switching period 1208 for each frequency pair within the frequency combination 1204. For example, the capability 1202 can include at least a first switching period for switching between a first frequency pair (e.g., ULTxSwitchingPeriod-frequencyIndexUL1_frequencyIndexUL2), a second switching period for switching between a second frequency pair (e.g., ULTxSwitchingPeriod-frequencyIndexUL1_frequencyIndexUL3), and a third switching period for switching between a third frequency pair (e.g., ULTxSwitchingPeriod-frequencyIndexUL2_frequencyIndexUL3).

The capability 1202 further includes frequency antenna information 1210 for each of the plurality uplink frequencies (e.g., frequencyIndexUL1, frequencyIndexUL2, and frequencyIndexUL3). In other examples, the capability 1202 may indicate frequency MIMO layer information similar to the frequency antenna information 1210. The frequency antenna information 1210 includes a first number of antennas supported by each uplink frequency (e.g., NumberAntennaSupported) and a second number of antennas enabled to switch from the respective uplink frequency (e.g., NumberAntennaSwitching). For example, the capability 1202 can include first frequency antenna information (e.g., frequencyIndexUL1_NumberAntennaSupported_NumberAntennaSwitching), second frequency antenna information (e.g., frequencyIndexUL2_NumberAntennaSupported_NumberAntennaSwitching), and third frequency antenna information (e.g., frequencyIndexUL3_NumberAntennaSupported_NumberAntennaSwitching).

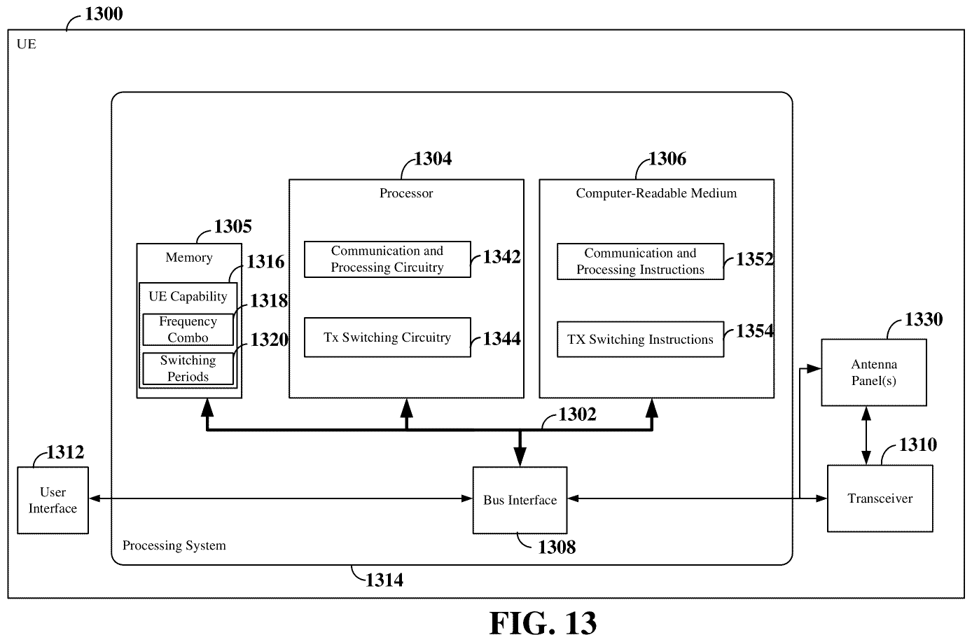

FIG. 13 is a block diagram illustrating an example of a hardware implementation of a user equipment (UE) 1300 employing a processing system 1314 according to some aspects. The UE 1300 may be any of the UEs or other scheduled entities illustrated in any one or more of FIGS. 1, 2, 5, 6, and/or 8-10.

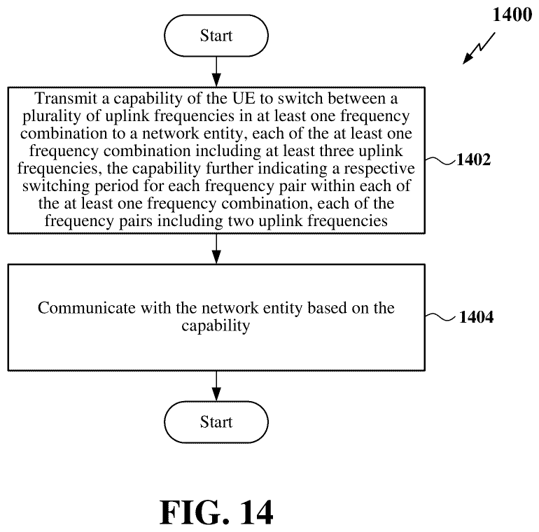

In accordance with various aspects of the disclosure, an element, or any portion of an element, or any combination of elements may be implemented with a processing system 1314 that includes one or more processors, such as processor 1304. Examples of processors 1304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1300 may be configured to perform any one or more of the functions described herein. That is, the processor 1304, as utilized in the UE 1300, may be used to implement any one or more of the methods or processes described and illustrated, for example, in FIG. 9 or 14.

The processor 1304 may in some instances be implemented via a baseband or modem chip and in other implementations, the processor 1304 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1314 may be implemented with a bus architecture, represented generally by the bus 1302. The bus 1302 may include any number of interconnecting buses and bridges depending on the specific application of the processing system 1314 and the overall design constraints. The bus 1302 communicatively couples together various circuits, including one or more processors (represented generally by the processor 1304), a memory 1305, and computer-readable media (represented generally by the computer-readable medium 1306). The bus 1302 may also link various other circuits such as timing sources, peripherals, voltage regulators, and power management circuits, which are well known in the art, and therefore, are not described any further.

A bus interface 1308 provides an interface between the bus 1302 and a transceiver 1310. The transceiver 1310 may be, for example, a wireless transceiver. The transceiver 1310 provides a means for communicating with various other apparatus over a transmission medium (e.g., air interface). The transceiver 1310 may further be coupled to one or more antenna panels 1330 configured to communicate on one or more uplink frequencies. The bus interface 1308 further provides an interface between the bus 1302 and a user interface 1312 (e.g., keypad, display, touch screen, speaker, microphone, control features, etc.). Of course, such a user interface 1312 may be omitted in some examples.

The computer-readable medium 1306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1306 may reside in the processing system 1314, external to the processing system 1314, or distributed across multiple entities including the processing system 1314. The computer-readable medium 1306 may be embodied in a computer program product. By way of example, a computer program product may include a computer-readable medium in packaging materials. In some examples, the computer-readable medium 1306 may be part of the memory 1305. Those skilled in the art will recognize how best to implement the described functionality presented throughout this disclosure depending on the particular application and the overall design constraints imposed on the overall system. In some examples, the computer-readable medium 1306 may be implemented on an article of manufacture, which may further include one or more other elements or circuits, such as the processor 1304 and/or memory 1305.

The computer-readable medium 1306 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 1304, may be responsible for managing the bus 1302 and general processing, including the execution of the software (e.g., instructions or computer-executable code) stored on the computer-readable medium 1306. The software, when executed by the processor 1304, causes the processing system 1314 to perform the various processes and functions described herein for any particular apparatus. The computer-readable medium 1306 and/or the memory 1305 may also be used for storing data that may be manipulated by the processor 1304 when executing software. For example, the memory 1305 may store a UE capability 1316 of the UE 1300 that includes one or more frequency combinations (e.g., Frequency combo) 1318 and associated switching periods (e.g., Switching Periods) 1320. The UE capability 1316 may be preconfigured on the UE, for example, by an original equipment manufacturer (OEM) of the UE 1300.

In some aspects of the disclosure, the processor 1304 may include circuitry configured for various functions. For example, the processor 1304 may include communication and processing circuitry 1342 configured to communicate with a network entity (e.g., an aggregated or disaggregated base station, such as a gNB or eNB). In some examples, the communication and processing circuitry 1342 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1342 may include one or more transmit/receive chains.

In some implementations where the communication involves receiving information, the communication and processing circuitry 1342 may obtain information from a component of the UE 1300 (e.g., from the transceiver 1310 that receives the information via radio frequency signaling or some other type of signaling suitable for the applicable communication medium), process (e.g., decode) the information, and output the processed information. For example, the communication and processing circuitry 1342 may output the information to another component of the processor 1304, to the memory 1305, or to the bus interface 1308. In some examples, the communication and processing circuitry 1342 may receive one or more of signals, messages, other information, or any combination thereof. In some examples, the communication and processing circuitry 1342 may receive information via one or more channels. In some examples, the communication and processing circuitry 1342 may include functionality for a means for receiving. In some examples, the communication and processing circuitry 1342 may include functionality for a means for processing, including a means for demodulating, a means for decoding, etc.

In some implementations where the communication involves sending (e.g., transmitting) information, the communication and processing circuitry 1342 may obtain information (e.g., from another component of the processor 1304, the memory 1305, or the bus interface 1308), process (e.g., modulate, encode, etc.) the information, and output the processed information. For example, the communication and processing circuitry 1342 may output the information to the transceiver 1310 (e.g., that transmits the information via radio frequency signaling or some other type of signaling suitable for the applicable communication medium). In some examples, the communication and processing circuitry 1342 may send one or more of signals, messages, other information, or any combination thereof. In some examples, the communication and processing circuitry 1342 may send information via one or more channels. In some examples, the communication and processing circuitry 1342 may include functionality for a means for sending (e.g., a means for transmitting). In some examples, the communication and processing circuitry 1342 may include functionality for a means for generating, including a means for modulating, a means for encoding, etc.

In some examples, the communication and processing circuitry 1342 may be configured to transmit (e.g., via the transceiver 1310) a capability of the UE (e.g., UE capability 1316) to switch between a plurality of uplink frequencies in at least one frequency combination 1318 to a network entity. Each of the at least one frequency combination 1318 includes at least three uplink frequencies. The capability 1316 further indicates a respective switching period 1320 for each frequency pair within each of the at least one frequency combination, where each frequency pair includes two uplink frequencies of the at least three frequencies.

In some examples, the respective switching period of a first frequency pair is different between respective frequency combinations of the at least one frequency combination. In some examples, the capability excludes a first switching period of a first frequency pair within a first frequency combination to indicate switching between the two uplink frequencies of the first frequency pair is unsupported.

In some examples, a first switching period of a first frequency pair within a first frequency combination of the at least one frequency combination includes a combination of a second switching period of a second frequency pair within the first frequency combination and a third switching period of a third frequency pair within the first frequency combination. In some examples, the second frequency pair and the third frequency pair each include an anchor uplink frequency providing a bridge between a first uplink frequency of the first frequency pair and a second uplink frequency of the first frequency pair. In some examples, the capability 1316 excludes the first switching period of the first frequency pair within the first frequency combination.

In some examples, the capability further indicates a respective first number of a respective set of antennas supported by each of the plurality of uplink frequencies and a respective second number of switching antennas within the respective set of antennas for each of the plurality of uplink frequencies that are enabled to switch to a different one of the plurality of uplink frequencies. For example, the respective first number may be different than the respective second number for at least one of the plurality of uplink frequencies. In some examples, the capability further indicates a respective first number of a respective set of multiple-input-multiple-output (MIMO) layers supported by each of the plurality of uplink frequencies and a respective second number of switching MIMO layers within the respective set of MIMO layers for each of the plurality of uplink frequencies that are enabled to switch to a different one of the plurality of uplink frequencies. For example, the respective first number may be different than the respective second number for at least one of the plurality of uplink frequencies.

The communication and processing circuitry 1342 may further be configured to communicate with the network entity via the transceiver 1310 and antenna panel(s) 1330 based on the capability 1316. The communication and processing circuitry 1342 may further be configured to execute communication and processing instructions (software) 1352 stored on the computer-readable medium 1306 to implement one or more functions described herein.

The processor 1304 may further include transmit (Tx) switching circuitry 1344 configured to switch one or more antennas (e.g., logical antenna ports of the antenna panel(s) 1330) between uplink frequencies based on the capability 1316. For example, the communication and processing circuitry 1342 may receive a request for the UE 1300 to switch one or more antennas from a first uplink frequency to a second uplink frequency within a particular frequency combination 1318.

The Tx switching circuitry 1344 may then switch the one or more antennas from the first uplink frequency to the second uplink frequency based on the switching period 1320 of the frequency pair including the first and second uplink frequencies within the frequency combination 1318. The Tx switching circuitry 1344 may further switch the one or more antennas based on frequency antenna information or MIMO layer information (e.g., as shown in FIG. 12) included within the UE capability 1316. The Tx switching circuitry 1344 may further be configured to execute Tx switching instructions (software) 1354 stored on the computer-readable medium 1306 to implement one or more functions described herein.

FIG. 14 is a flow chart illustrating an exemplary process 1400 for communicating with a network entity based on an uplink frequency capability of a UE according to some aspects. As described below, some or all illustrated features may be omitted in a particular implementation within the scope of the present disclosure, and some illustrated features may not be required for implementation of all embodiments. In some examples, the process 1400 may be carried out by the UE 1300 illustrated in FIG. 13. In some examples, the process 1400 may be carried out by any suitable apparatus or means for carrying out the functions or algorithm described below.

At block 1402, the UE may transmit a capability of the UE to switch between a plurality of uplink frequencies in at least one frequency combination to a network entity. Each of the at least one frequency combination includes at least three uplink frequencies. The capability further indicates a respective switching period for each frequency pair within each of the at least one frequency combination, where each of the frequency pairs includes two uplink frequencies of the at least three uplink frequencies.

In some examples, the respective switching period of a first frequency pair is different between respective frequency combinations of the at least one frequency combination. In some examples, the capability excludes a first switching period of a first frequency pair within a first frequency combination to indicate switching between the two uplink frequencies of the first frequency pair is unsupported.

In some examples, a first switching period of a first frequency pair within a first frequency combination of the at least one frequency combination includes a combination of a second switching period of a second frequency pair within the first frequency combination and a third switching period of a third frequency pair within the first frequency combination. In some examples, the second frequency pair and the third frequency pair each include an anchor uplink frequency providing a bridge between a first uplink frequency of the first frequency pair and a second uplink frequency of the first frequency pair. In some examples, the capability 1316 excludes the first switching period of the first frequency pair within the first frequency combination.

In some examples, the capability further indicates a respective first number of a respective set of antennas supported by each of the plurality of uplink frequencies and a respective second number of switching antennas within the respective set of antennas for each of the plurality of uplink frequencies that are enabled to switch to a different one of the plurality of uplink frequencies. For example, the respective first number may be different than the respective second number for at least one of the plurality of uplink frequencies. In some examples, the capability further indicates a respective first number of a respective set of multiple-input-multiple-output (MIMO) layers supported by each of the plurality of uplink frequencies and a respective second number of switching MIMO layers within the respective set of MIMO layers for each of the plurality of uplink frequencies that are enabled to switch to a different one of the plurality of uplink frequencies. For example, the respective first number may be different than the respective second number for at least one of the plurality of uplink frequencies. For example, the communication and processing circuitry 1342 together with the transceiver 1310 shown and described above in connection with FIG. 13 may provide a means to transmit the capability to the network entity.

At block 1404, the UE may communicate with the network entity based on the capability. For example, the communication and processing circuitry 1342, together with the Tx switching circuitry 1344, transceiver 1310, and antenna panel(s) 1330, shown and described above in connection with FIG. 13 may provide a means to communicate with the network entity based on the capability.

In one configuration, the UE includes means for transmitting a capability of the UE to switch between a plurality of uplink frequencies in at least one frequency combination to a network entity, each of the at least one frequency combination including at least three uplink frequencies, the capability further indicating a respective switching period for each frequency pair within each of the at least one frequency combination, each of the frequency pairs including two uplink frequencies. The UE further including means for communicating with the network entity based on the capability. In one aspect, the aforementioned means may be the processor 1304 shown in FIG. 13 configured to perform the functions recited by the aforementioned means. In another aspect, the aforementioned means may be a circuit or any apparatus configured to perform the functions recited by the aforementioned means.

Of course, in the above examples, the circuitry included in the processor 1304 is merely provided as an example, and other means for carrying out the described functions may be included within various aspects of the present disclosure, including but not limited to the instructions stored in the computer-readable storage medium 1306, or any other suitable apparatus or means described in any one of the FIGS. 1, 2, 5, 6, and 8-10, and utilizing, for example, the processes and/or algorithms described herein in relation to FIGS. 8 and 13.

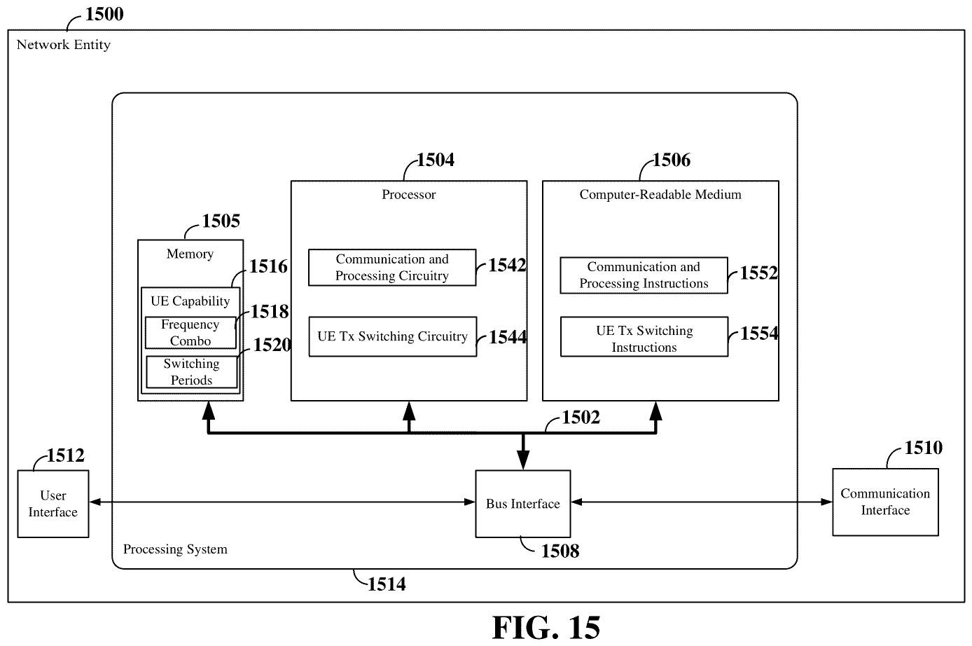

FIG. 15 is a block diagram illustrating an example of a hardware implementation of a network entity 1500 employing a processing system 1514 according to some aspects. The network entity 1500 may be, for example, any base station (e.g., gNB, eNB) or other scheduling entity as illustrated in any one or more of FIGS. 1, 2, 4-6, and/or 8-10. The network entity 1500 may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In addition, the network entity 1500 may be a stationary network entity or a mobile network entity.

In accordance with various aspects of the disclosure, an element, or any portion of an element, or any combination of elements may be implemented with a processing system 1514 that includes one or more processors, such as processor 1504. The processing system 1514 may be substantially the same as the processing system 1314 as shown and described above in connection with FIG. 13, including a bus interface 1508, a bus 1502, a memory 1505, a processor 1504, and a computer-readable medium 1506. Accordingly, their descriptions will not be repeated for the sake of brevity. Furthermore, the network entity 1500 may include an optional user interface 1512 and a communication interface 1510. The communication interface 1510 may provide an interface (e.g., wireless or wired) between the network entity 1500 and a plurality of transmission and reception points (TRPs), a core network node, and/or a plurality of UEs. In some examples, the communication interface 1510 may include a wireless transceiver.

The processor 1504, as utilized in the network entity 1500, may be used to implement any one or more of the processes described below. In some examples, the memory 1505 may store a UE capability 1516 of a UE that includes one or more frequency combinations (e.g., Frequency combo) 1518 and associated switching periods (e.g., Switching Periods) 1520.

In some aspects of the disclosure, the processor 1504 may include communication and processing circuitry 1542 configured for various functions, including, for example, communicating with one or more UEs or other scheduled entities, or a core network node. In some examples, the communication and processing circuitry 1542 may communicate with one or more UEs via one or more TRPs associated with the network entity 1500. In some examples, the communication and processing circuitry 1542 may include one or more hardware components that provide the physical structure that performs processes related to wireless communication (e.g., signal reception and/or signal transmission) and signal processing (e.g., processing a received signal and/or processing a signal for transmission). In addition, the communication and processing circuitry 1542 may be configured to process and transmit downlink traffic and downlink control and receive and process uplink traffic and uplink control.

In some examples, the communication and processing circuitry 1542 may be configured to receive (e.g., via the communication interface 1510) a capability of the UE (e.g., UE capability 1516) to switch between a plurality of uplink frequencies in at least one frequency combination 1518. The communication and processing circuitry 1542 may further be configured to store the capability 1516, for example, within the memory 1505. Each of the at least one frequency combination 1518 includes at least three uplink frequencies. The capability 1516 further indicates a respective switching period 1520 for each frequency pair within each of the at least one frequency combination, where each frequency pair includes two uplink frequencies of the at least three frequencies.

In some examples, the respective switching period of a first frequency pair is different between respective frequency combinations of the at least one frequency combination. In some examples, the capability excludes a first switching period of a first frequency pair within a first frequency combination to indicate switching between the two uplink frequencies of the first frequency pair is unsupported.

In some examples, a first switching period of a first frequency pair within a first frequency combination of the at least one frequency combination includes a combination of a second switching period of a second frequency pair within the first frequency combination and a third switching period of a third frequency pair within the first frequency combination. In some examples, the second frequency pair and the third frequency pair each include an anchor uplink frequency providing a bridge between a first uplink frequency of the first frequency pair and a second uplink frequency of the first frequency pair. In some examples, the capability 1516 excludes the first switching period of the first frequency pair within the first frequency combination.

In some examples, the capability further indicates a respective first number of a respective set of antennas supported by each of the plurality of uplink frequencies and a respective second number of switching antennas within the respective set of antennas for each of the plurality of uplink frequencies that are enabled to switch to a different one of the plurality of uplink frequencies. For example, the respective first number may be different than the respective second number for at least one of the plurality of uplink frequencies. In some examples, the capability further indicates a respective first number of a respective set of multiple-input-multiple-output (MIMO) layers supported by each of the plurality of uplink frequencies and a respective second number of switching MIMO layers within the respective set of MIMO layers for each of the plurality of uplink frequencies that are enabled to switch to a different one of the plurality of uplink frequencies. For example, the respective first number may be different than the respective second number for at least one of the plurality of uplink frequencies.

The communication and processing circuitry 1542 may further be configured to communicate with the UE via the communication interface 1510 based on the capability 1516. The communication and processing circuitry 1542 may further be configured to execute communication and processing instructions (software) 1552 stored on the computer-readable medium 1506 to implement one or more functions described herein.

The processor 1504 may further include UE Tx switching circuitry 1544 configured to configure the UE (e.g., transmit a message via the communication and processing circuitry 1542) to switch one or more antennas of the UE between uplink frequencies based on the capability 1516. For example, the communication and processing circuitry 1542 may transmit a request to the UE to switch one or more antennas from a first uplink frequency to a second uplink frequency within a particular frequency combination 1518 based on the switching period 1520 associated with the frequency pair including the first and second uplink frequency within the frequency combination 1518. In some examples, the UE Tx switching circuitry 1544 may further request the UE to switch one or more antennas from the first uplink frequency to the second uplink frequency based on frequency antenna information or MIMO layer information (e.g., as shown in FIG. 12) included within the UE capability 1516. The UE Tx switching circuitry 1544 may further be configured to execute UE Tx switching instructions (software) 1554 stored on the computer-readable medium 1506 to implement one or more functions described herein.

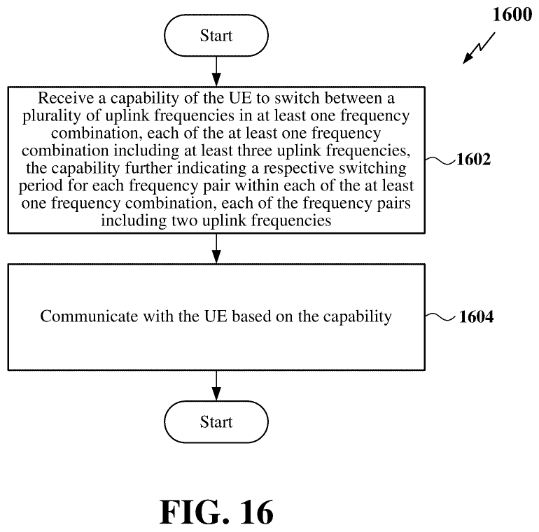

FIG. 16 is a flow chart illustrating an exemplary process 1600 for communicating with a UE based on an uplink frequency switching capability of the UE according to some aspects. As described below, some or all illustrated features may be omitted in a particular implementation within the scope of the present disclosure, and some illustrated features may not be required for implementation of all embodiments. In some examples, the process 1600 may be carried out by the network entity 1500 illustrated in FIG. 15. In some examples, the process 1600 may be carried out by any suitable apparatus or means for carrying out the functions or algorithm described below.

At block 1602, the network entity may receive a capability of the UE to switch between a plurality of uplink frequencies in at least one frequency combination. Each of the at least one frequency combination includes at least three uplink frequencies. The capability further indicates a respective switching period for each frequency pair within each of the at least one frequency combination, where each of the frequency pairs includes two uplink frequencies.

In some examples, the respective switching period of a first frequency pair is different between respective frequency combinations of the at least one frequency combination. In some examples, the capability excludes a first switching period of a first frequency pair within a first frequency combination to indicate switching between the two uplink frequencies of the first frequency pair is unsupported.

In some examples, a first switching period of a first frequency pair within a first frequency combination of the at least one frequency combination includes a combination of a second switching period of a second frequency pair within the first frequency combination and a third switching period of a third frequency pair within the first frequency combination. In some examples, the second frequency pair and the third frequency pair each include an anchor uplink frequency providing a bridge between a first uplink frequency of the first frequency pair and a second uplink frequency of the first frequency pair. In some examples, the capability 1516 excludes the first switching period of the first frequency pair within the first frequency combination.

In some examples, the capability further indicates a respective first number of a respective set of antennas supported by each of the plurality of uplink frequencies and a respective second number of switching antennas within the respective set of antennas for each of the plurality of uplink frequencies that are enabled to switch to a different one of the plurality of uplink frequencies. For example, the respective first number may be different than the respective second number for at least one of the plurality of uplink frequencies. In some examples, the capability further indicates a respective first number of a respective set of multiple-input-multiple-output (MIMO) layers supported by each of the plurality of uplink frequencies and a respective second number of switching MIMO layers within the respective set of MIMO layers for each of the plurality of uplink frequencies that are enabled to switch to a different one of the plurality of uplink frequencies. For example, the respective first number may be different than the respective second number for at least one of the plurality of uplink frequencies. For example, the communication and processing circuitry 1542, together with the communication interface 1510, shown and described above in connection with FIG. 15 may provide a means to receive the capability.

At block 1604, the network entity may communicate with the UE based on the capability. For example, the communication and processing circuitry 1542, together with the UE Tx switching circuitry 1544 and communication interface 1510, shown and described above in connection with FIG. 15 may provide a means to communicate with the UE based on the capability.

In one configuration, the network entity includes means for receiving a capability of the UE to switch between a plurality of uplink frequencies in at least one frequency combination, each of the at least one frequency combination including at least three uplink frequencies, the capability further indicating a respective switching period for each frequency pair within each of the at least one frequency combination, each of the frequency pairs including two uplink frequencies. The network entity further includes means for communicating with the UE based on the capability. In one aspect, the aforementioned means may be the processor 1504 shown in FIG. 15 configured to perform the functions recited by the aforementioned means. In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of FIGS. 1, 2, 4-6, and 8-10, and utilizing, for example, the processes and/or algorithms described herein in relation to FIGS. 8 and 16.

The following provides an overview of aspects of the present disclosure:

Aspect 1: A method for wireless communication at a user equipment (UE), the method comprising: transmitting a capability of the UE to switch between a plurality of uplink frequencies in at least one frequency combination to a network entity, each of the at least one frequency combination comprising at least three uplink frequencies, the capability further indicating a respective switching period for each frequency pair within each of the at least one frequency combination, each of the frequency pairs comprising two uplink frequencies of the at least three uplink frequencies; and communicating with the network entity based on the capability.

Aspect 2: The method of aspect 1, wherein the respective switching period of a first frequency pair is different between respective frequency combinations of the at least one frequency combination.

Aspect 3: The method of aspect 1 or 2, wherein a first switching period of a first frequency pair within a first frequency combination of the at least one frequency combination comprises a combination of a second switching period of a second frequency pair within the first frequency combination and a third switching period of a third frequency pair within the first frequency combination.

Aspect 4: The method of aspect 3, wherein the second frequency pair and the third frequency pair each include an anchor uplink frequency providing a bridge between a first uplink frequency of the first frequency pair and a second uplink frequency of the first frequency pair.

Aspect 5: The method of aspect 3 or 4, wherein the first switching period is equal to a sum of the second switching period and the third switching period.

Aspect 6: The method of any of aspects 3 through 5, wherein the capability excludes the first switching period of the first frequency pair within the first frequency combination.

Aspect 7: The method of aspect 1 or 2, wherein the capability excludes a first switching period of a first frequency pair within a first frequency combination to indicate switching between the two uplink frequencies of the first frequency pair is unsupported.

Aspect 8: The method of any of aspects 1 through 7, wherein the capability further indicates a respective first number of a respective set of antennas supported by each of the plurality of uplink frequencies and a respective second number of switching antennas within the respective set of antennas for each of the plurality of uplink frequencies that are enabled to switch to a different one of the plurality of uplink frequencies.

Aspect 9: The method of aspect 8, wherein the respective first number is different than the respective second number for at least one of the plurality of uplink frequencies.

Aspect 10: The method of any of aspects 1 through 7, wherein the capability further indicates a respective first number of a respective set of multiple-input-multiple-output (MIMO) layers supported by each of the plurality of uplink frequencies and a respective second number of switching MIMO layers within the respective set of MIMO layers for each of the plurality of uplink frequencies that are enabled to switch to a different one of the plurality of uplink frequencies.

Aspect 11: The method of aspect 10, wherein the respective first number is different than the respective second number for at least one of the plurality of uplink frequencies.

Aspect 12: A method for wireless communication at a network entity, the method comprising: receiving a capability of a user equipment (UE) to switch between a plurality of uplink frequencies in at least one frequency combination, each of the at least one frequency combination comprising at least three uplink frequencies, the capability further indicating a respective switching period for each frequency pair within each of the at least one frequency combination, each of the frequency pairs comprising two uplink frequencies of the at least three uplink frequencies; and communicating with the UE based on the capability.

Aspect 13: The method of aspect 12, wherein the respective switching period of a first frequency pair is different between respective frequency combinations of the at least one frequency combination.

Aspect 14: The method of any of aspect 12 or 13, wherein a first switching period of a first frequency pair within a first frequency combination of the at least one frequency combination comprises a combination of a second switching period of a second frequency pair within the first frequency combination and a third switching period of a third frequency pair within the first frequency combination.

Aspect 15: The method of aspect 14, wherein the second frequency pair and the third frequency pair each include an anchor uplink frequency providing a bridge between a first uplink frequency of the first frequency pair and a second uplink frequency of the first frequency pair.

Aspect 16: The method of aspect 14 or 15, wherein the first switching period is equal to a sum of the second switching period and the third switching period.

Aspect 17: The method of any of aspects 14 through 16, wherein the capability excludes the first switching period of the first frequency pair within the first frequency combination.

Aspect 18: The method of aspect 12 or 13, wherein the capability excludes a first switching period of a first frequency pair within a first frequency combination to indicate switching between the two uplink frequencies of the first frequency pair is unsupported.

Aspect 19: The method of any of aspects 12 through 18, wherein the capability further indicates a respective first number of a respective set of antennas supported by each of the plurality of uplink frequencies and a respective second number of switching antennas within the respective set of antennas for each of the plurality of uplink frequencies that are enabled to switch to a different one of the plurality of uplink frequencies.

Aspect 20: The method of aspect 19, wherein the respective first number is different than the respective second number for at least one of the plurality of uplink frequencies.

Aspect 21: The method of any of aspects 12 through 18, wherein the capability further indicates a respective first number of a respective set of multiple-input-multiple-output (MIMO) layers supported by each of the plurality of uplink frequencies and a respective second number of switching MIMO layers within the respective set of MIMO layers for each of the plurality of uplink frequencies that are enabled to switch to a different one of the plurality of uplink frequencies.

Aspect 22: The method of aspect 21, wherein the respective first number is different than the respective second number for at least one of the plurality of uplink frequencies.

Aspect 23: An apparatus comprising a memory and a processor coupled to the memory, wherein the processor is configured to perform a method of any of aspects 1 through 11 or 12 through 22.

Aspect 24: An apparatus comprising means for performing a method of any of aspects 1 through 11 or 12 through 22.

Aspect 25: A non-transitory computer-readable medium having stored therein instructions configured to cause one or more processors of an apparatus to perform a method of any of aspects 1 through 11 or 12 through 22.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIG. 1-16 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4-6, 8-10, 13, and/or 15 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A user equipment (UE), comprising:
a transceiver configured to communicate with a network entity;
a memory; and
a processor coupled to the transceiver and the memory, the processor being configured to:
transmit a capability of the UE to switch between a plurality of uplink frequencies in at least one frequency combination to a network entity, each of the at least one frequency combination comprising at least three uplink frequencies, the capability further indicating a respective switching period for each frequency pair within each of the at least one frequency combination, each of the frequency pairs comprising two uplink frequencies of the at least three uplink frequencies; and
communicate with the network entity based on the capability.

2. The UE of claim 1, wherein the respective switching period of a first frequency pair is different between respective frequency combinations of the at least one frequency combination.

3. The UE of claim 1, wherein a first switching period of a first frequency pair within a first frequency combination of the at least one frequency combination comprises a combination of a second switching period of a second frequency pair within the first frequency combination and a third switching period of a third frequency pair within the first frequency combination.

4. The UE of claim 3, wherein the second frequency pair and the third frequency pair each include an anchor uplink frequency providing a bridge between a first uplink frequency of the first frequency pair and a second uplink frequency of the first frequency pair.

5. The UE of claim 3, wherein the first switching period is equal to a sum of the second switching period and the third switching period.

6. The UE of claim 3, wherein the capability excludes the first switching period of the first frequency pair within the first frequency combination.

7. The UE of claim 1, wherein the capability excludes a first switching period of a first frequency pair within a first frequency combination to indicate switching between the two uplink frequencies of the first frequency pair is unsupported.

8. The UE of claim 1, wherein the capability further indicates a respective first number of a respective set of antennas supported by each of the plurality of uplink frequencies and a respective second number of switching antennas within the respective set of antennas for each of the plurality of uplink frequencies that are enabled to switch to a different one of the plurality of uplink frequencies.

9. The UE of claim 8, wherein the respective first number is different than the respective second number for at least one of the plurality of uplink frequencies.

10. The UE of claim 1, wherein the capability further indicates a respective first number of a respective set of multiple-input-multiple-output (MIMO) layers supported by each of the plurality of uplink frequencies and a respective second number of switching MIMO layers within the respective set of MIMO layers for each of the plurality of uplink frequencies that are enabled to switch to a different one of the plurality of uplink frequencies.

11. The UE of claim 10, wherein the respective first number is different than the respective second number for at least one of the plurality of uplink frequencies.

12. A method for wireless communication at a user equipment (UE), the method comprising:
transmitting a capability of the UE to switch between a plurality of uplink frequencies in at least one frequency combination to a network entity, each of the at least one frequency combination comprising at least three uplink frequencies, the capability further indicating a respective switching period for each frequency pair within each of the at least one frequency combination, each of the frequency pairs comprising two uplink frequencies of the at least three uplink frequencies; and
communicating with the network entity based on the capability.

13. The method of claim 12, wherein the respective switching period of a first frequency pair is different between respective frequency combinations of the at least one frequency combination.

14. The method of claim 12, wherein a first switching period of a first frequency pair within a first frequency combination of the at least one frequency combination comprises a combination of a second switching period of a second frequency pair within the first frequency combination and a third switching period of a third frequency pair within the first frequency combination, the second frequency pair and the third frequency pair each include an anchor uplink frequency providing a bridge between a first uplink frequency of the first frequency pair and a second uplink frequency of the first frequency pair.

15. The method of claim 14, wherein the capability excludes the first switching period of the first frequency pair within the first frequency combination.

16. The method of claim 12, wherein the capability further indicates a respective first number of a respective set of antennas or respective set of multiple-input-multiple-output (MIMO) layers supported by each of the plurality of uplink frequencies and a respective second number of switching antennas within the respective set of antennas or switching MIMO layers within the respective set of MIMO layers for each of the plurality of uplink frequencies that are enabled to switch to a different one of the plurality of uplink frequencies.

17. A network entity, comprising:
a memory; and
a processor coupled to the memory, the processor configured to:
receive a capability of a user equipment (UE) to switch between a plurality of uplink frequencies in at least one frequency combination, each of the at least one frequency combination comprising at least three uplink frequencies, the capability further indicating a respective switching period for each frequency pair within each of the at least one frequency combination, each of the frequency pairs comprising two uplink frequencies of the at least three uplink frequencies;
and communicate with the UE based on the capability.

18. The network entity of claim 17, wherein the respective switching period of a first frequency pair is different between respective frequency combinations of the at least one frequency combination.

19. The network entity of claim 17, wherein a first switching period of a first frequency pair within a first frequency combination of the at least one frequency combination comprises a combination of a second switching period of a second frequency pair within the first frequency combination and a third switching period of a third frequency pair within the first frequency combination.

20. The network entity of claim 19, wherein the second frequency pair and the third frequency pair each include an anchor uplink frequency providing a bridge between a first uplink frequency of the first frequency pair and a second uplink frequency of the first frequency pair.

21. The network entity of claim 19, wherein the capability excludes the first switching period of the first frequency pair within the first frequency combination.

22. The network entity of claim 17, wherein the capability excludes a first switching period of a first frequency pair within a first frequency combination to indicate switching between the two uplink frequencies of the first frequency pair is unsupported.

23. The network entity of claim 17, wherein the capability further indicates a respective first number of a respective set of antennas supported by each of the plurality of uplink frequencies and a respective second number of switching antennas within the respective set of antennas for each of the plurality of uplink frequencies that are enabled to switch to a different one of the plurality of uplink frequencies.

24. The network entity of claim 23, wherein the respective first number is different than the respective second number for at least one of the plurality of uplink frequencies.

25. The network entity of claim 17, wherein the capability further indicates a respective first number of a respective set of multiple-input-multiple-output (MIMO) layers supported by each of the plurality of uplink frequencies and a respective second number of switching MIMO layers within the respective set of MIMO layers for each of the plurality of uplink frequencies that are enabled to switch to a different one of the plurality of uplink frequencies.

26. The network entity of claim 25, wherein the respective first number is different than the respective second number for at least one of the plurality of uplink frequencies.

27. A method for wireless communication at a network entity, comprising:
receiving a capability of a user equipment (UE) to switch between a plurality of uplink frequencies in at least one frequency combination, each of the at least one frequency combination comprising at least three uplink frequencies, the capability further indicating a respective switching period for each frequency pair within each of the at least one frequency combination, each of the frequency pairs comprising two uplink frequencies of the at least three uplink frequencies; and
communicating with the UE based on the capability.

28. The method of claim 27, wherein the respective switching period of a first frequency pair is different between respective frequency combinations of the at least one frequency combination.

29. The method of claim 27, wherein a first switching period of a first frequency pair within a first frequency combination of the at least one frequency combination comprises a combination of a second switching period of a second frequency pair within the first frequency combination and a third switching period of a third frequency pair within the first frequency combination, the second frequency pair and the third frequency pair each including an anchor uplink frequency providing a bridge between a first uplink frequency of the first frequency pair and a second uplink frequency of the first frequency pair.

30. The method of claim 27, wherein the capability further indicates a respective first number of a respective set of antennas or respective set of multiple-input-multiple-output (MIMO) layers supported by each of the plurality of uplink frequencies and a respective second number of switching antennas within the respective set of antennas or switching MIMO layers within the respective set of MIMO layers for each of the plurality of uplink frequencies that are enabled to switch to a different one of the plurality of uplink frequencies.
